(19) United States
(12) Patent Application Publication
(10) Pub. No.: US 2023/0162492 A1
(43) Pub. Date: May 25, 2023

(54) METHOD, SERVER DEVICE, AND SYSTEM FOR PROCESSING OFFLOADED DATA

(71) Applicant: SEOUL NATIONAL UNIVERSITY R&DB FOUNDATION, Seoul (KR)

(72) Inventors: Kyunghan LEE, Seoul (KR); Sungyong Lee, Seoul (KR)

(73) Assignee: SEOUL NATIONAL UNIVERSITY R&DB FOUNDATION, Seoul (KR)

(21) Appl. No.: 17/991,392

(22) Filed: Nov. 21, 2022

(30) Foreign Application Priority Data
Nov. 22, 2021 (KR) 10-2021-0161674
Nov. 17, 2022 (KR) 10-2022-0154653

(51) Int. Cl. G06V 10/82; G06V 10/22; G06V 10/774

(52) U.S. Cl. CPC G06V 10/82; G06V 10/22; G06V 10/774

(57) ABSTRACT

Provided are a method, server device, and system for processing offloaded data, the method including receiving the offloaded data from a terminal device, decoding the offloaded data by using a decoder model, and outputting inferred data corresponding to the offloaded data by using a deep neural network model having received the decoded data as an input, wherein the offloaded data includes latent representation data generated by an extractor model having received original data as an input, and the extractor model, the decoder model, and the deep neural network model are jointly trained by using loss information of the deep neural network model.

### CROSS-REFERENCE TO RELATED APPLICATION

This application is based on and claims priority under 35 U.S.C. § 119 to Korean Patent Application No. 10-2021-0161674, filed on Nov. 22, 2021, and Korean Patent Application No. 10-2022-0154653, filed on Nov. 17, 2022, in the Korean Intellectual Property Office, the disclosure of which is incorporated by reference herein in its entirety.

### BACKGROUND

### 1. Field

The disclosure relates to a method, server device, and system for processing offloaded data, and more particularly, to a method, server device, and system for processing offloaded data, by which a decoder model and a deep neural network model may be jointly trained.

### 2. Description of the Related Art

Recently, deep neural network-based services have been widely used in devices capable of performing wireless communication, such as Internet-of-things (IoT) devices or smart phones.

Offloading is emerging to solve the problem of insufficient computational resources of such devices. However, excessive offloading requests from numerous devices cause significant trouble in network bandwidth utilization.

In areas with large network bandwidth, such as in urban areas, the amount of data transmitted for deep neural network (DNN) offloading is manageable, however, such data occupies a large portion of the network bandwidth, and thus, the available network bandwidth usable by users is reduced, resulting in lowering the user experience.

Such a problem becomes more serious in areas with small network bandwidth, such as in shanty towns. In such an area, the network bandwidth cannot adequately cover the amount of data transmitted for DNN offloading from the beginning, resulting in DNN services not being properly provided, and the available network bandwidth is eliminated, which greatly lowers the network user experience.

To solve such problems, it is necessary to use a bandwidth, and one promising solution for this is to offload compressed data.

However, the related-art image compression technology is designed such that a resulting image is recognizable by human eyes, and thus has a limitation in compression rate.

FIG. 1 is a conceptual diagram for describing a case in which an image is compressed such that its restored image has no difference with the original image when viewed by human eyes.

As illustrated in FIG. 1, that an image is compressed such that the restored image has no difference with the original image when viewed by human eyes means that the result of the compression includes information required for viewing by human eyes, rather than information required for processing by a DNN.

FIG. 2 is a conceptual diagram for describing a method of cropping an image to obtain a region of interest and compressing the region of interest to be input to a DNN for a desired purpose.

Referring to FIG. 2, by removing, from spatial information, unnecessary information for processing by a DNN, a higher compression ratio than that of the method illustrated in FIG. 2 may be achieved.

However, in the method illustrated in FIG. 2, the unnecessary information for the processing by the DNN is identified from only the spatial information, which is a small part of the original image, and thus, the actually restored image is recognizable by human eyes.

### SUMMARY

The disclosure is to provide a deep neural network-based data compression method and system capable of connecting a deep neural network-based encoder with a deep neural network and performing joint training by using a loss function of the deep neural network.

The disclosure is to provide a method, server device, and system for processing offloaded data, by which an extractor model, a decoder model, and a deep neural network model may be jointly trained.

Technical objects of the disclosure are not limited to the foregoing, and other unmentioned objects of the disclosure would be more clearly understood by those of skill in the art from the following description.

Additional aspects will be set forth in part in the description which follows and, in part, will be apparent from the description, or may be learned by practice of the presented embodiments of the disclosure.

According to an embodiment, there may be provided a deep neural network-based method of compressing data to be used for an application service using a deep neural network, in which an encoder based on machine learning to be used, and the deep neural network used for the application service are connected to each other, and then jointly trained by using a loss function for performance of the deep neural network.

An encoder according to an embodiment may include deep learning techniques used for an encoder, such as an autoencoder, an autoencoder used as a generative model, or a generative model.

The data according to an embodiment may include at least one of an image, a video, a text, and a sensor value to be used for the application service.

The loss function used for the joint training according to an embodiment may be the loss function of the deep neural network alone, or may be a combination of the loss function of the deep neural network and another loss function.

According to an embodiment, the deep neural network used for the application service may serve as a decoder, instead of a decoder included in the encoder.

According to an embodiment, the decoder may be completely or partially removed.

According to an embodiment, an input structure modifier for transforming compressed data into the format of an input value of the deep neural network may be further included.

The input structure modifier according to an embodiment may include a non-machine learning-based technique, such as upsampling and reshaping, and a machine learning-based technique involving a convolutional layer.

According to an embodiment, there may be provided a deep neural network-based method of compressing data to be used for an application service, which includes a compression technique for connecting an encoder based on machine learning to be used, to a deep neural network used for the application service, and then jointly training them by using a loss function for performance of the deep neural network.

A method of processing offloaded data according to an embodiment may include receiving the offloaded data from a terminal device, decoding the offloaded data by using a decoder model, and outputting inferred data corresponding to the offloaded data by using a deep neural network model having received the decoded data as an input. According to an embodiment, the offloaded data may include latent representation data generated by an extractor model having received original data as an input. According to an embodiment, the extractor model, the decoder model, and the deep neural network model may be jointly trained by using loss information of the deep neural network model.

A server device for processing offloaded data according to an embodiment may include a memory storing one or more instructions, and at least one processor configured to execute the one or more instructions stored in the memory. The at least one processor may be further configured to execute the one or more instructions to receive the offloaded data from a terminal device, decode the offloaded data by using a decoder model, and output inferred data corresponding to the offloaded data by using a deep neural network model having received the decoded data as an input. According to an embodiment, the offloaded data may include latent representation data generated by an extractor model having received original data as an input. According to an embodiment, the extractor model, the decoder model, and the deep neural network model may be jointly trained by using loss information of the deep neural network model.

An offloading system according to an embodiment may include a terminal device and a server device. The terminal device may include a camera configured to obtain an image corresponding to original data, a first memory storing one or more instructions, and at least one first processor configured to execute the one or more instructions stored in the first memory. The at least one first processor may be further configured to execute the one or more instructions stored in the first memory to generate latent representation data by using an extractor model having received the original data as an input, and offload the latent representation data onto the server device. The server device may include a second memory storing one or more instructions, and at least one second processor configured to execute the one or more instructions stored in the second memory. The at least one second processor may be further configured to execute the one or more instructions to receive the offloaded data from the terminal device, decode the offloaded data by using a decoder model, and output inferred data corresponding to the offloaded data by using a deep neural network model having received the decoded data as an input. According to an embodiment, the offloaded data may include latent representation data generated by an extractor model having received original data as an input. According to an embodiment, the extractor model, the decoder model, and the deep neural network model may be jointly trained by using loss information of the deep neural network model.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a conceptual diagram for describing a case in which an image is compressed such that its restored image has no difference with the original image when viewed by human eyes;

FIG. 2 is a conceptual diagram for describing a method of cropping an image to obtain a region of interest and compressing the region of interest to be input to a deep neural network for a desired purpose;

FIG. 3 is a conceptual diagram for describing extracting, compressing, and transmitting only essential information for a deep neural network, according to the disclosure;

FIG. 4 is an exemplary diagram for describing a case in which deep neural networks require different information;

FIG. 5 is an exemplary diagram for describing a case in which deep neural networks require different information;

FIG. 6 is a configuration diagram for describing a related-art deep neural network-based compression technique;

FIG. 7 is a configuration diagram for describing a deep neural network-based compression technique according to an embodiment;

FIG. 8 is a configuration diagram for describing a deep neural network-based compression technique according to an embodiment;

FIG. 9 is a configuration diagram showing that an input structure modifier of FIG. 8 may be implemented as an upsampler;

FIG. 10 is a hierarchical structure diagram of a convolutional layer;

FIG. 11 is a hierarchical structure diagram of a transposed convolutional layer;

FIG. 12 is a block diagram illustrating an example in which a data compression method according to an embodiment may be applied;

FIG. 13 is a block diagram illustrating an offloading system according to an embodiment;

FIG. 14 is a block diagram illustrating a training server device according to an embodiment;

FIG. 15 is a block diagram illustrating an offloading system according to an embodiment;

FIG. 16 is a block diagram illustrating a training server device according to an embodiment;

FIG. 17 is a block diagram illustrating in more detail an extractor model and a decoder model according to an embodiment;

FIG. 18 is a block diagram illustrating in more detail an extractor model and a decoder model according to an embodiment;

FIG. 19 is a block diagram illustrating an offloading system according to an embodiment; and

FIG. 20 is a flowchart illustrating a method of processing offloaded data according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Advantages and features of the disclosure and a method for achieving them will be apparent with reference to embodiments described below together with the attached drawings. The disclosure is not limited to the embodiments described below, but may be implemented in various different forms, the embodiments are solely provided to make the disclosure complete and to allow those of skill in the art to which the disclosure pertains to clearly understand the scope of the disclosure, and thus, the disclosure is only defined by the scope of the claims.

In addition, in describing the disclosure, when the detailed description of the relevant known functions or configurations is determined to unnecessarily obscure the gist of the disclosure, the detailed description thereof may be omitted. Also, the terms as used herein are those defined by taking into account functions in the disclosure, and may vary depending on the intention of users or operators, precedents, or the like. Therefore, the terms should be defined based on the technical spirit described throughout the present specification.

Hereinafter, preferred embodiments are described with reference to the accompanying drawings.

In related-art deep neural network (DNN) offloading techniques using a compression technique, an encoder and a DNN are trained separately from each other, in which case, the encoder is trained considering restoration of original data and thus outputs unnecessary information for processing by the DNN, which is an obstacle to increasing the compression ratio.

In the technique proposed herein, by connecting a machine learning-based encoder with a neural network to be used in a DNN service are connected with each other, and then performing joint training by using a loss function indicating the performance of a DNN, unnecessary information for the performance of the DNN may be removed without considering restoration of original data (that is, the encoder compresses only information required by the DNN), and thus, a higher compression ratio that that of the related-art compression technique may be realized.

According to the disclosure, proposed is a technique of inputting a decoder (i.e., a restorer) of a deep learning-based encoder (i.e., a compressor), as compressed data, into a DNN used for an application service by additionally utilizing that the decoder and the DNN are based on the same neural network.

FIG. 3 is a conceptual diagram for describing extracting, compressing, and transmitting only essential information for a DNN, according to the disclosure.

Referring to FIG. 3, the method proposed herein is to achieve the maximum compression rate while maintaining the performance of the DNN by extracting and compressing only information that is actually essential for the DNN without considering how it appears to human eyes.

In the compression technique according to the disclosure, a restored image is unrecognizable by human eyes, however, this is not a problem in a case in which the original image is not required for a DNN to perform its task, such as in a case of a DNN equipped in an autonomous vehicle to measure a distance and determine how to travel.

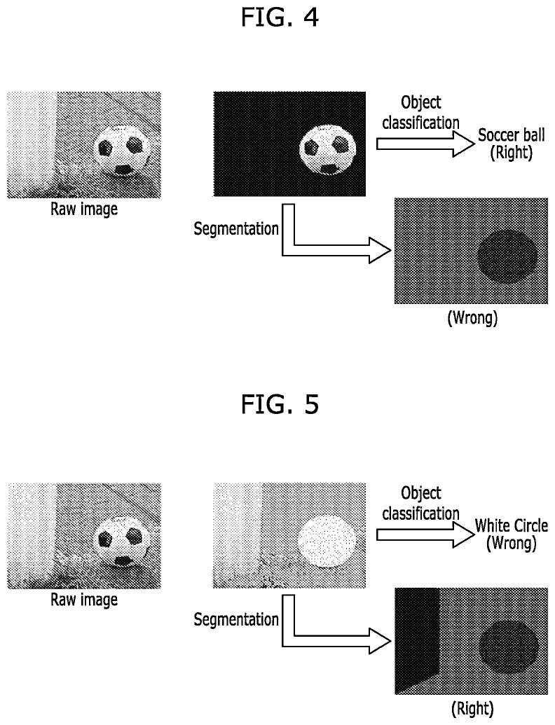

FIG. 4 is an exemplary diagram for describing a case in which DNNs require different information.

Referring to FIG. 4, from an image from which the background other than the ball is removed, a DNN for object classification may accurately identify the soccer ball.

However, a DNN for segmentation may output an erroneous result from the same image, because the goalpost region is missing in the image.

FIG. 5 is an exemplary diagram for describing a case in which DNNs require different information.

Referring to FIG. 5, when the pattern of the soccer ball is removed unlike the example illustrated in FIG. 5, the DNN for object classification may be unable to determine whether the white circle is a soccer ball, a baseball, or a golf ball.

However, the DNN for segmentation may derive a correct result because the goalpost and the edge of the ball remain in the image.

The related-art image compression techniques include lossless compression techniques (e.g., lossless codecs) and lossy compression techniques (e.g., lossly codecs), and for example, the lossy image compression techniques remove information that is not required for viewing by human eyes without any difference from the original image, thereby increasing the compression rate while allowing the restored image to appear the same as the original image to human eyes.

That is, the compressed image contains information for image restoration that is unnecessary for the processing by a DNN, and thus, there is room for increasing the compression rate.

In addition, DNNs differ in required information from each other, and referring to FIG. 4, the DNN for segmentation may derive a correct result even from an image obtained by removing details of the original image, such as, the pattern of the ball.

However, a DNN for classifying types of balls may be unable to classify the white circle as a soccer ball from the image because the pattern of the ball is removed in the image. Therefore, there is a need for a compression technique that may achieve a high compression rate by removing unnecessary information for the application of each DNN.

To this end, the disclosure proposes a DNN-based compression technique in order to design a compression technique that extracts essential information for each DNN and removes unnecessary information.

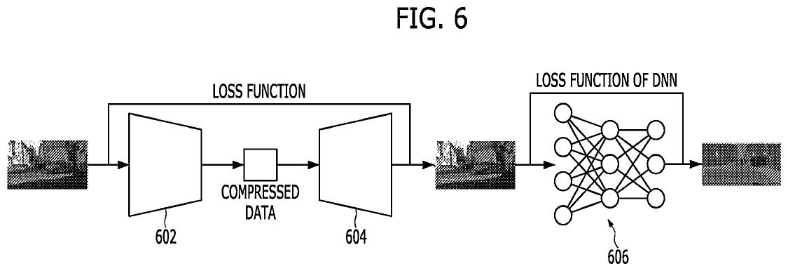

FIG. 6 is a configuration diagram for describing a related-art DNN-based compression technique, and illustrates a structure in which an encoder 602 and a decoder 604 are connected to a DNN 606.

Referring to FIG. 6, in the related-art DNN-based compression technique, the DNN-based encoder 602 is trained by using a loss function representing the difference between an original image and a restored image, and the DNN 606 is trained by using a loss function for improving the performance of the DNN 606.

As such, data (e.g., image) restored by the decoder 604 is similar to original data. Here, the data may include at least one of images, videos, texts, and sensor values that are used for an application service.

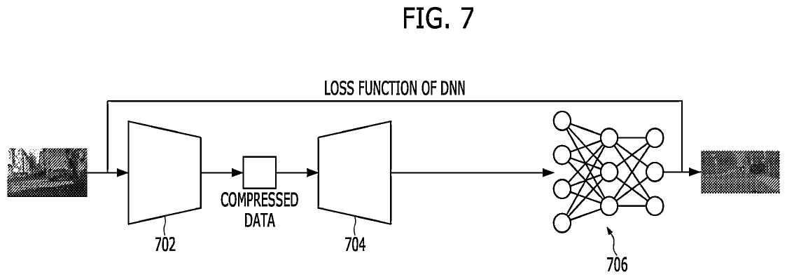

FIG. 7 is a configuration diagram for describing a DNN-based compression technique according to an embodiment, and illustrates a structure in which an encoder 702 and a decoder 704 are connected to a DNN 706. Here, the encoder 702 and the decoder 704 may include, for example, machine learning techniques utilized for an autoencoder or a generative model.

Referring to FIG. 7, in a training process of the compression technique according to an embodiment, the DNN-based encoder 702 and decoder 704 are connected to the DNN 706, and joint training is performed by using a loss function of the DNN 706. As such, the DNN-based encoder 702 removes unnecessary information for the performance of the DNN 706.

Accordingly, an image restored through the encoder 702 and the decoder 704 may be composed of features for the DNN 706, which are unrecognizable by human eyes.

For example, the loss function used for the joint training may be the loss function of the DNN 706 alone, or may be a combination of the loss function of the DNN 706 and another loss function.

In addition, a DNN used for a DNN-based application service may be designed to serve as a decoder instead of a decoder, and the decoder 704 may be completely removed or only a part thereof may remain.

Despite such a configuration, the performance of the DNN may be fully maintained because it contains information for the performance of the DNN.

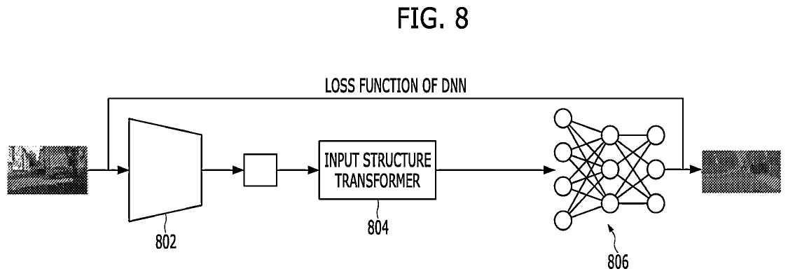

FIG. 8 is a configuration diagram for describing a DNN-based compression technique according to an embodiment, and illustrates a structure in which an encoder 802 and an input structure modifier 804 are connected to a DNN 806. Here, the encoder 802 may include, for example, machine learning techniques utilized for an autoencoder or a generative model.

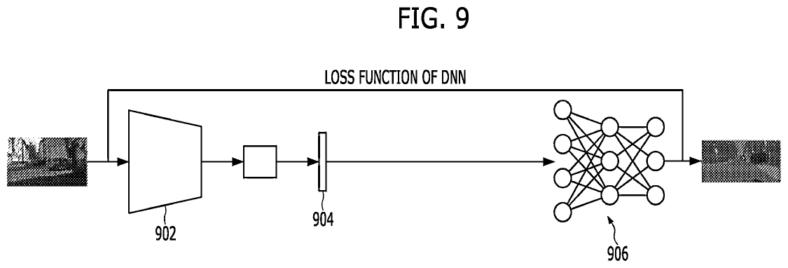

FIG. 9 is a configuration diagram showing that the input structure modifier 804 of FIG. 8 may be implemented as an upsampler 904.

To this end, referring to FIG. 9, a compression technique implemented with upsampling has a structure in which an encoder 902 and the upsampler 904 are coupled to a DNN 906.

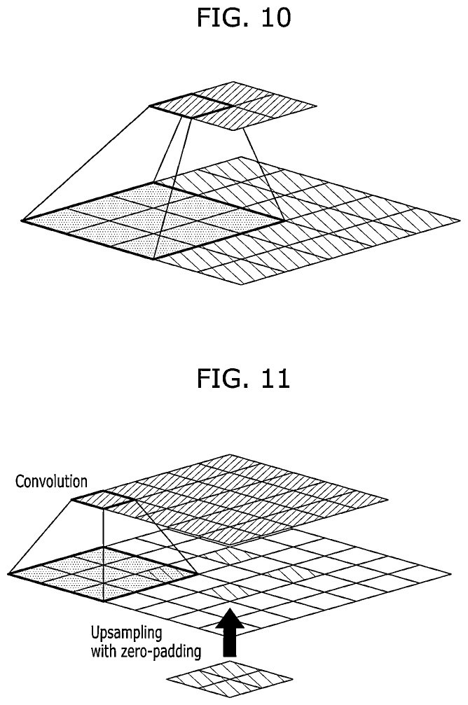

FIG. 10 is a hierarchical structure diagram of a convolutional layer, and FIG. 11 is a hierarchical structure diagram of a transposed convolutional layer.

Referring to FIG. 8, the input structure modifier 804 may have a structure for inputting data compressed by a decoder of a deep learning-based encoder into a DNN used for an application service by utilizing that the decoder and the DNN are based on the same neural network.

For example, in a case in which the types of an encoder and a DNN used for an application service are convolutional neural network (CNN), a transposed convolutional layer constituting the CNN-based encoder is composed of a convolution layer and an upsampler, and thus the decoder may be replaced with an upsampling layer and decoding may be performed by the DNN.

That is, the upsampling layer serves as an input structure modifier, and generally speaking, by adding, as a replacement for the decoder, an input structure modifier that modifies compressed data to fit the structure of an input to the DNN, the compressed data may be directly input to the DNN without being decoded, so as to shorten and save the time and computational resources used for decoding.

The input structure modifier 804 may include, for example, a non-machine learning-based technique, such as upsampling and reshaping, and a machine learning-based technique involving a convolutional layer.

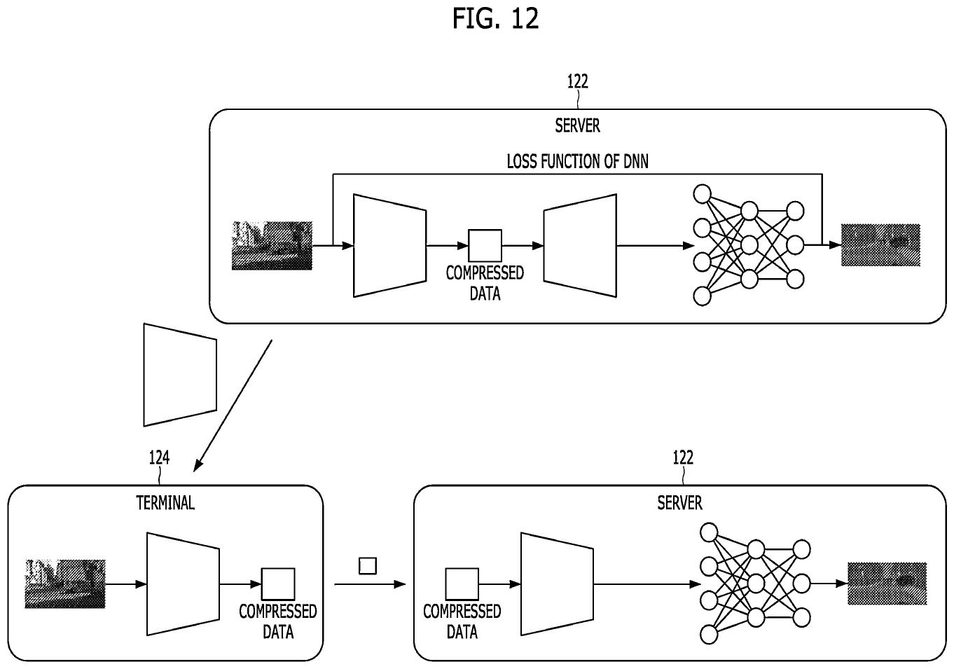

FIG. 12 is a block diagram illustrating an example in which a data compression method according to an embodiment may be applied.

Referring to FIG. 12, the data compression method according to an embodiment may operate in the following manner.

1) Offline training may be performed by using a loss function of a DNN according to the present embodiment to jointly train an encoder and the DNN.

2) A server 122 transmits the trained encoder to a terminal 124.

3) When a DNN offloading service is executed by the terminal 124, input data is compressed by the trained encoder, and then the compressed input data is transmitted to the server 122.

4) When using the input structure modifier 804 of FIG. 8 according to an embodiment, the server 122 may perform DNN computations by inputting the compressed data received from the terminal 124 into the DNN without decoding.

When the input structure modifier 804 of FIG. 8 according to an embodiment is not used, the server 122 may perform DNN computations by restoring original data from the compressed data through the decoder and then inputting the restored original data into the DNN.

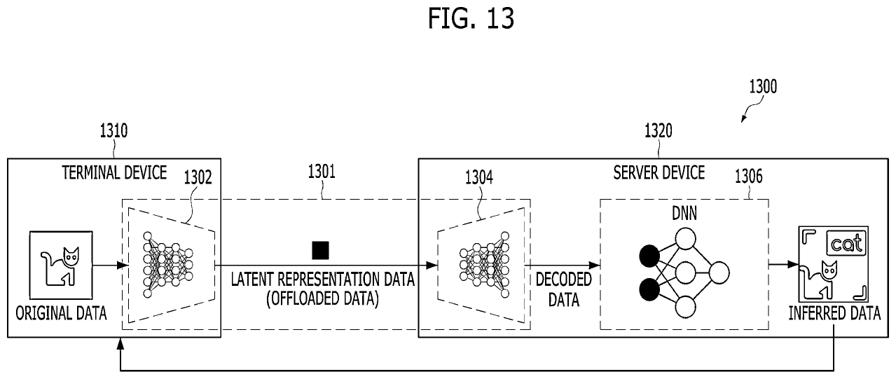

FIG. 13 is a block diagram illustrating an offloading system according to an embodiment. An offloading system 1300 may include a terminal device 1310 and a server device 1320.

The offloading system 1300 may be a system that allows the server device 1320 to process at least part of tasks of an application executed by the terminal device 1310. The offloading system 1300 may be a system that allows the server device 1320 to process at least part of a DNN-based task among tasks of an application.

The terminal device 1310 may obtain original data. For example, the original data may be at least one of an image, a video, an audio, a text, and a sensor value. According to an embodiment, the terminal device 1310 may obtain the original data by using an external device or an input device (e.g., a camera, a sensor, or a microphone). For example, the terminal device 1310 may obtain the original data (e.g., an image) through a camera. According to an embodiment, the terminal device 1310 may obtain the original data by loading data stored in a memory or a storage.

The terminal device 1310 may generate latent representation data by using an extractor model 1302 having received the original data as an input. The extractor model 1302 may extract, from the original data, essential information, i.e., the latent representation data. Here, the essential information may refer to minimum information required for inference using a DNN 1306. The term ‘latent representation data’ may also be referred to as ‘latent vector’.

In an embodiment, the extractor model 1302 may correspond to an encoder of an autoencoder. For example, the extractor model 1302 may include at least one convolutional layer.

The terminal device 1310 may offload the latent representation data onto the server device 1320. The terminal device 1310 may transmit the latent representation data to the server device 1320 through a network. The server device 1320 may receive the offloaded data (i.e., the latent representation data) through the network.

In an embodiment, the size of the latent representation data may be predefined. Accordingly, the size of the latent representation data may be fixed to a value according to a setting of a manufacturer or a user. According to an embodiment, the size of the latent representation data is predefined, and thus, the bandwidth adaptability of a communication channel for transmitting and receiving the latent representation data may be increased.

The terminal device 13110 according to an embodiment may be implemented in various forms. For example, the terminal device 1310 may include, but is not limited to, a smart phone, a laptop computer, a personal computer (PC), a tablet PC, a digital camera, a closed-circuit television (CCTV), an e-book terminal, a digital broadcast terminal, a personal digital assistant (PDA), a portable multimedia player (PMP), a navigation device, an MP3 player, and the like.

The server device 1320 may receive the offloaded data from the terminal device 1310. The server device 1320 may decode the offloaded data by using a decoder model 1304. The decoder model 1304 may correspond to a decoder of an autoencoder. For example, the decoder model 1304 may include at least one convolutional layer. In an embodiment, the extractor model 1302 and the decoder model 1304 may be implemented as an autoencoder model 1301.

In an embodiment, the term ‘decoding’ may refer to an operation of converting low-dimensional data into high-dimensional data (e.g., a data format conversion operation). For example, the server device 1320 may decode the offloaded data by converting the offloaded data into the form of an input value of the DNN model 1306. Thus, the offloaded latent representation data may be reconstructed. According to an embodiment, the decoder model 1304 may operate as a simple data format converter, thereby alleviating the computational load of the server device 1320 without degrading the inference accuracy of the DNN.

The server device 1320 may output inferred data corresponding to the original data (or the offloaded data) by using the DNN model 1306 having received the decoded data as an input. For example, the DNN model 1306 may be a model that performs image classification, image segmentation, image captioning, object detection, depth estimation, localization, or pose estimation, but the disclosure is not limited thereto. For example, in a case in which the DNN model 1306 is a model for classifying animals, the DNN model 1306 may infer, from an input of an image or a video in which a cat is captured, that an object in the image or the video is a cat. For example, in a case in which the DNN model 1306 is a model for classifying scenes of a CCTV video, the DNN model 1306 may infer, from an input of an image or a video in which a criminal scene is captured, that a criminal scene is captured in the image or the video.

The server device 1320 may transmit the inferred data to the terminal device 1310. The terminal device 1310 may receive the inferred data. The terminal device 1310 may provide an application service by using the inferred data.

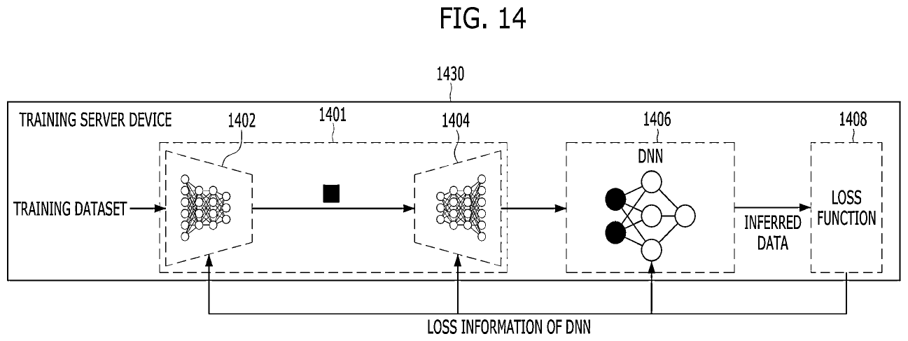

In an embodiment, the extractor model 1302, the decoder model 1304, and the DNN model 1306 may be jointly trained by using loss information of the DNN model 1306. An example in which the extractor model 1302, the decoder model 1304, and the DNN model 1306 are jointly trained is described in detail with reference to FIG. 14.

FIG. 14 is a block diagram illustrating a training server device according to an embodiment. The extractor model 1302, the decoder model 1304, and the DNN model 1306 of FIG. 13 may correspond to results of training an extractor model 1402, a decoder model 1404, and a DNN model 1406, respectively. For convenience of description, the descriptions provided above with reference to FIG. 13 are omitted.

A training server device 1430 may jointly train the extractor model 1402, the decoder model 1404, and the DNN model 1406 by using training dataset as an input. In an embodiment, the extractor model 1402 and the decoder model 1404 may be trained by using a training method for an autoencoder model 1401.

The training server device 1430 may compare inferred data with ground truth values corresponding to the training dataset by using a loss function 1408. Throughout the present specification, a resulting value of the loss function 1408 may be referred to as loss information.

The training server device 1430 may jointly train the extractor model 1402, the decoder model 1404, and the DNN model 1406 by using a loss information of the DNN model 1406. According to an embodiment, only the loss information of the DNN model 1406 is utilized in the training of the extractor model 1402 and the decoder model 1404, without using loss information of each of the extractor model 1402 and the decoder model 1404.

A parameter optimization equation for jointly training the extractor model 1402, the decoder model 1404, and the DNN model 1406 by using the loss information of the DNN model 1406 according to an embodiment may be represented by Equation 1.

$${w}_{A}^{*} , {w}_{D}^{*} = {arg min}_{{w}_{A} , {w}_{D}} DL ( y , {D}_{{w}_{D}} ( {A}_{{w}_{A}} ( x ) ) ) + α \cdot H ( z ) \qquad [ Equation 1 ]$$

In Equation 1, 1, w_{D} denotes a (current) training parameter set of the DNN model 1406, w_{A} denotes a (current) training parameter set of the extractor model 1402 and the decoder model 1404, DL denotes the loss function 1408 of the DNN model 1406, D_{w}_{_{D}} denotes values of inferred data output by using w_{D}, A_{W}_{_{A}} denotes values of decoded data output by using w_{A}, H denotes an entropy function, α denotes weight values, x denotes original data, y denotes ground truth values, and z denotes latent representation data.

w_{D}* denotes an optimized training parameter set of the DNN model 1406, and w_{A}*denotes an optimized training parameter set of the extractor model 1402 and the decoder model 1404. In an embodiment, the first term of the equation for calculating w may be related to data distortion, and the second term may be related to the compression capability of the extractor model 1402. In an embodiment, a may be 0 to 1, and may vary depending on a setting of the user or the manufacturer.

Accordingly, the training server device 1430 may update the current training parameter sets of the extractor model 1402, the decoder model 1404, and the DNN model 1406 to minimize the value of the loss function 1408 of the DNN model 1406.

In an embodiment, the size of the latent representation data may be predefined. In this case, the second term of the equation for calculating w_{A}* in Equation 1 may be omitted, and the parameter optimization equation may be represented by Equation 2.

$${w}_{A}^{*} , {w}_{D}^{*} = {arg min}_{{w}_{A} , {w}_{D}} DL ( y , {D}_{{w}_{D}} ( {A}_{{w}_{A}} ( x ) ) ) \qquad [ Equation 2 ]$$

Referring to Equation 2, unlike Equation 1, the equation for calculating w_{D}* is the same as the equation for calculating w_{A}*. According to an embodiment, by limiting the size of the latent representation data to a predefined size, the usefulness of information may be maximized in minimizing the loss of the DNN model 1406.

In an embodiment, the training server device 1430 may be the same device as the server device 1320 of FIG. 13, but the disclosure is not limited thereto. Therefore, the training server device 1430 may be a separate device from the server device 1320 of FIG. 13. In this case, the training server device 1430 may transmit, to the server device 1320 of FIG. 13, the extractor model 1402, the decoder model 1404, and the DNN model 1406, which are completely jointly trained.

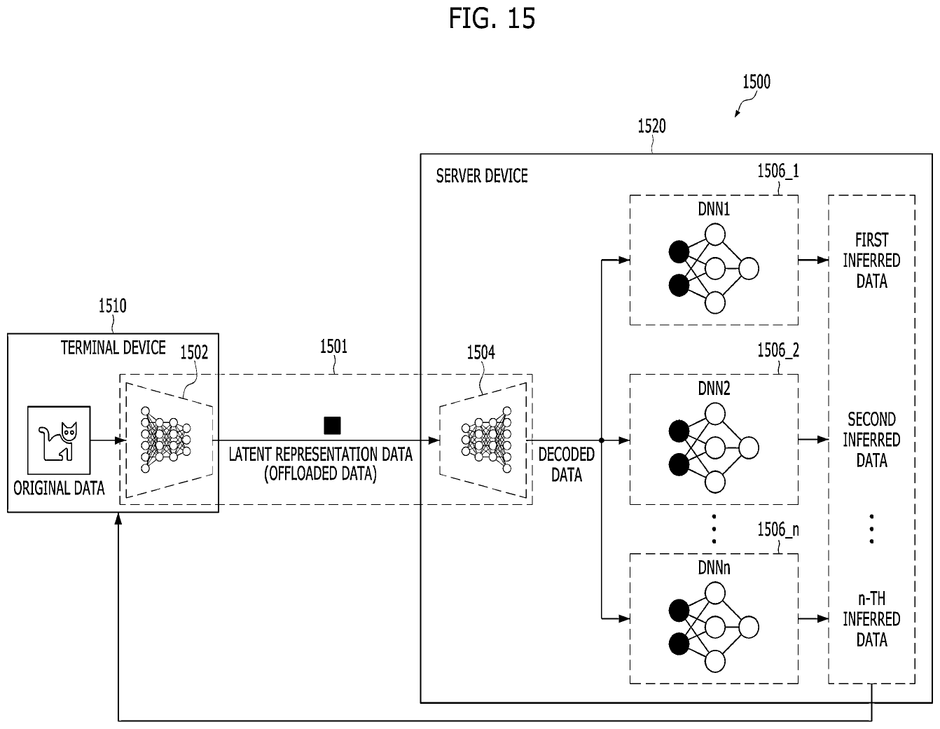

FIG. 15 is a block diagram illustrating an offloading system according to an embodiment. The components (e.g., 1301, 1302, and 1304), functions, and operations of the terminal device 1310 and the server device 1320 of FIG. 13 may corresponds to the components (e.g., 1501, 1502, and 1504), functions, and operations of a terminal device 1510 and a server device 1520. The DNN model 1306 of FIG. 13 may correspond to each of a plurality of DNN models 1506_1, 1506_2, . . . , 1506_n (hereinafter, also referred to as the first, second, . . . , and n-th DNN models 1506_1, 1506_2, . . . , and 1506_n). For convenience of description, the descriptions provided above with reference to FIG. 13 are omitted.

In an embodiment, the server device 1520 may output inferred data corresponding to original data (or offloaded data) by using the plurality of DNN models 1506_1, 1506_2, . . . , and 1506_n, that receive decoded data as an input. For example, the server device 1520 may output first inferred data by using the first DNN model 1506_1 that receives decoded data as an input. For example, the server device 1520 may output second inferred data by using the second DNN model 1506_2 that receives decoded data as an input. For example, the server device 1520 may output n-th inferred data by using the n-th DNN model 1506_n that receives decoded data as an input. For example, n may be a natural number greater than or equal to 2.

The server device 1520 may transmit the first to n-th inferred data to the terminal device 1510. The terminal device 1510 may receive the first to n-th inferred data. The terminal device 1510 may provide an application service by using the first to n-th inferred data.

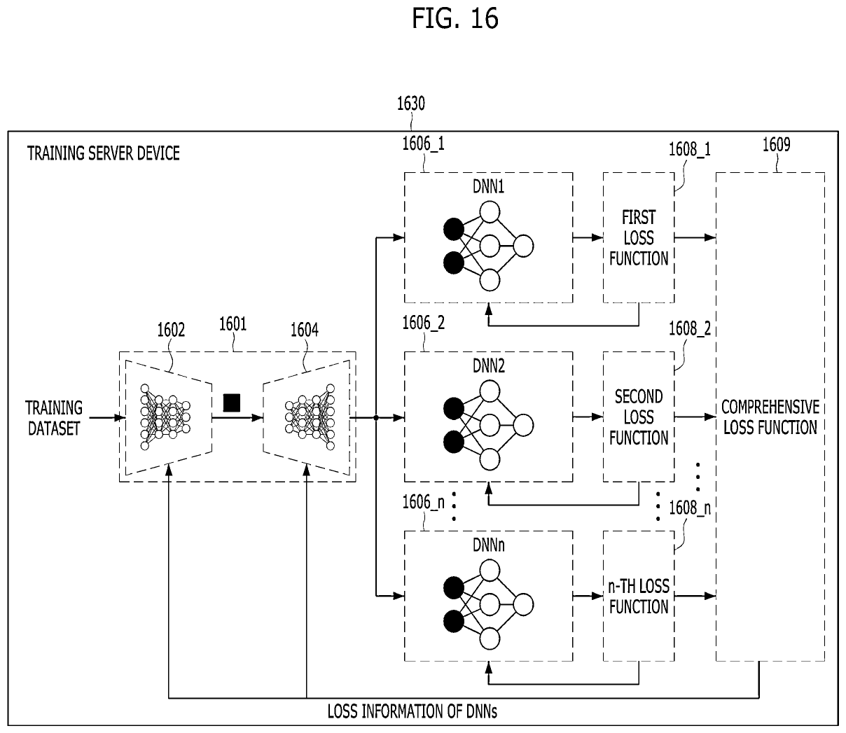

In an embodiment, an extractor model 1502 and a decoder model 1504 may be jointly trained by using loss information of the plurality of DNN models 1506_1, 1506_2, . . . , and 1506_n. In an embodiment, the plurality of DNN models 1506_1, 1506_2, . . . , and 1506_n may be trained by using the respective loss information of the plurality of DNN models 1506_1, 1506_2, . . . , and 1506_n. An example in which the extractor model 1502, the decoder model 1504, and the plurality of DNN models 1506_1, 1506_2, . . . , and 1506_n are jointly trained is described in detail with reference to FIG. 16.

FIG. 16 is a block diagram illustrating a training server device according to an embodiment. The extractor model 1502, the decoder model 1504, and the plurality of DNN models 1506_1, 1506_2, . . . , 1506_n of FIG. 15 may correspond to results of training an extractor model 1602, a decoder model 1604, and a plurality of DNN models 1606_1, 1606_2, . . . , and 1606_n (hereinafter, also referred to as the first, second, . . . , and n-th DNN models 1506_1, 1506_2, . . . , and 1506_n), respectively. For convenience of description, the descriptions provided above with reference to FIG. 15 are omitted.

A training server device 1630 may jointly train the extractor model 1602, the decoder model 1604, and the plurality of DNN models 1606_1, 1606_2, . . . , and 1606_n, by using a training dataset as an input. In an embodiment, the extractor model 1602 and the decoder model 1604 may be trained by using a training method for an autoencoder model 1601.

The training server device 1630 may compare first to n-th inferred data with ground truth values corresponding to the training dataset, by using a plurality of loss functions 1608_1, 1608_2, . . . , and 1608_n (hereinafter, also referred to as the first, second, . . . , and n-th loss functions 1608_1, 1608_2, . . . , and 1608_n) corresponding to the plurality of DNN models 1606_1, 1606_2, . . . , and 1606_n, respectively.

The training server device 1630 may jointly train the extractor model 1602, the decoder model 1604, and the plurality of DNN models 1606_1, 1606_2, . . . , and 1606_n by using loss information of the plurality of DNN models 1606_1, 1606_2, . . . , and 1606_n. For example, the first DNN model 1606_1 may be trained by using first loss information from the first loss function 1608_1. For example, the second DNN model 1606_2 may be trained by using second loss information from the second loss function 1608_2. For example, the n-th DNN model 1606_n may be trained by using n-th loss information from the n-th loss function 1608_n.

The training server device 1630 may obtain comprehensive loss information by using a comprehensive loss function 1609. The comprehensive loss information may be a weighted sum of the loss information of the plurality of loss functions 1608_1, 1608_2, . . . , and 1608_n. The training server device 1630 may train the extractor model 1602 and the decoder model 1604 by using the comprehensive loss information.

According to an embodiment, the extractor model 1602 and the decoder model 1604 are trained by using the comprehensive loss information including all loss information corresponding to the plurality of DNN models 1606_1, 1606_2, . . . , and 1606_n, and thus, there is no need to train an extractor model and a decoder model for each of the plurality of DNN models 1606_1, 1606_2, . . . , and 1606_n. According to an embodiment, there is no need to receive latent representation data to be input to each of the plurality of DNN models 1606_1, 1606_2, . . . , and 1606_n, and thus, the amount of data to be transmitted through a network may be reduced.

The comprehensive loss function 1609 according to an embodiment may be represented by Equation 3.

ML(Y,Ŷ)Σᵢ₌₁^{N}βᵢ·DLᵢ(yᵢ,ŷᵢ) [Equation 3]

In Equation 3, DLᵢ denotes a loss function corresponding to an i-th DNN model (i.e., an i-th loss function), yᵢ denotes ground truth values corresponding to the i-th DNN model, ŷᵢ denotes inferred data output by the i-th DNN model, βᵢ denotes weights corresponding to the i-th loss function, N denotes the number of DNN models, ML denotes the comprehensive loss function 1609, Y denotes a set of yᵢ, and Ŷ denotes a set of ŷᵢ. In an embodiment, the i-th DNN model may be trained by using DLᵢ, and the extractor model and the decoder model may be trained by using ML.

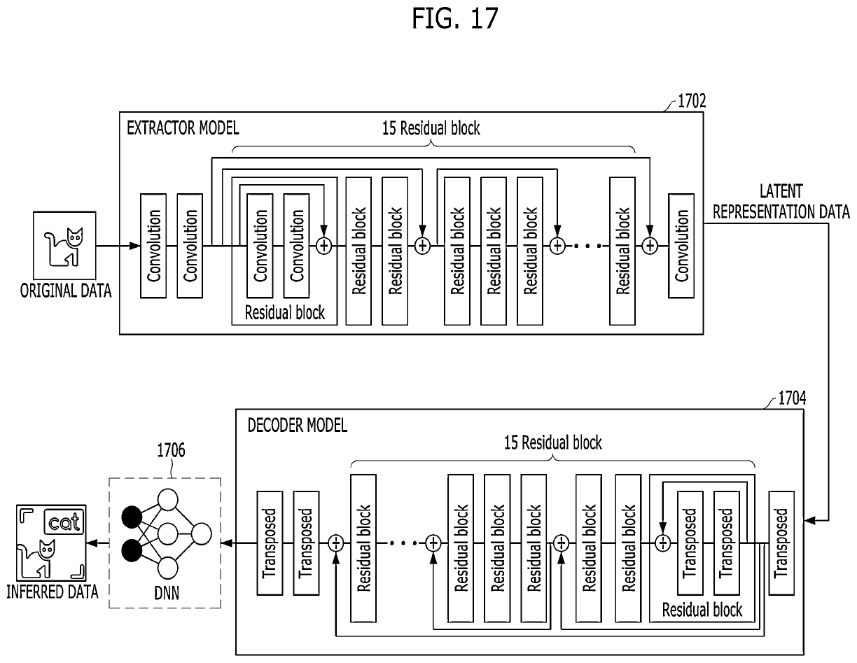

FIG. 17 is a block diagram illustrating in more detail an extractor model and a decoder model according to an embodiment. The functions and operations of an extractor model 1702, a decoder model 1704, and a DNN model 1706 correspond to those of the extractor models 1302, 1402, 1502, and 1602, the decoder models 1304, 1404, 1504, and 1604, and the DNN models 1306, 1406, 1506_1, 1506_2, . . . , 1506_n, 1606_1, 1606_2, . . . , and 1606_n), and thus, the descriptions thereof provided above are omitted.

Referring to FIG. 17, the extractor model 1702 according to an embodiment may include a plurality of convolutional layers. Each of the convolutional layers processes input data by using a filter having a preset size to obtain feature data. Although FIG. 17 illustrates that the extractor model 1702 is composed of 33 convolutional layers, but this is an example, and the disclosure is not limited thereto. Accordingly, the number of convolutional layers included in the extractor model 1702 may be variously modified. The number and size of filters used in each convolutional layer may be variously changed, and the order and method of connection between the convolutional layers may also be variously changed. In an embodiment, at least some of the plurality of convolutional layers may be configured as a residual block. For example, two convolutional layers may constitute one residual block. The extractor model 1702 may add input data of a residual block to output data of the residual block.

The decoder model 1704 according to an embodiment may include a plurality of transposed convolutional layers. The decoder model 1704 may be implemented in a structure in which the structure of the extractor model 1702 is transposed. Accordingly, the plurality of transposed convolutional layers of the decoder model 1704 correspond to the plurality of convolutional layers of the extractor model 1702, and thus, the descriptions thereof provided above are omitted.

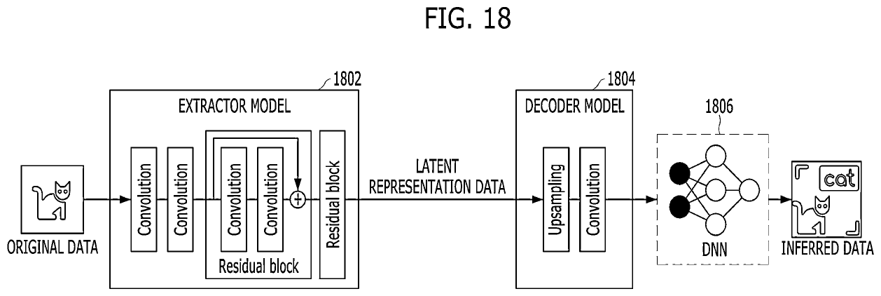

FIG. 18 is a block diagram illustrating in more detail an extractor model and a decoder model according to an embodiment. The functions and operations of an extractor model 1802, a decoder model 1804, and a DNN model 1806 correspond to those of the extractor models 1302, 1402, 1502, and 1602, the decoder models 1304, 1404, 1504, and 1604, and the DNN models 1306, 1406, 1506_1, 1506_2, . . . , 1506_n, 1606_1, 1606_2, . . . , and 1606_n), and thus, the descriptions thereof provided above are omitted.

In an embodiment, the extractor model 1802 may be trained by using a knowledge distillation technique. For example, the extractor model 1702 of FIG. 17 may serve as a teacher model, and the extractor model 1802 may serve as a student model. According to an embodiment, the extractor model 1802 may be lightweight by using the knowledge distillation technique.

In an embodiment, the decoder model 1804 may be implemented as a simple data format converter, rather than a complex decoder structure of an autoencoder. For example, the decoder model 1804 may transform latent representation data into the format of an input value of the DNN model 1806. Although FIG. 18 illustrates that the decoder model 1804 is composed of a single upsampling layer and a single convolutional layer, but this is an example, and the disclosure is not limited thereto. According to an embodiment, by simplifying the structure of the decoder model 1804, the decoder model 1804 may be lightweight.

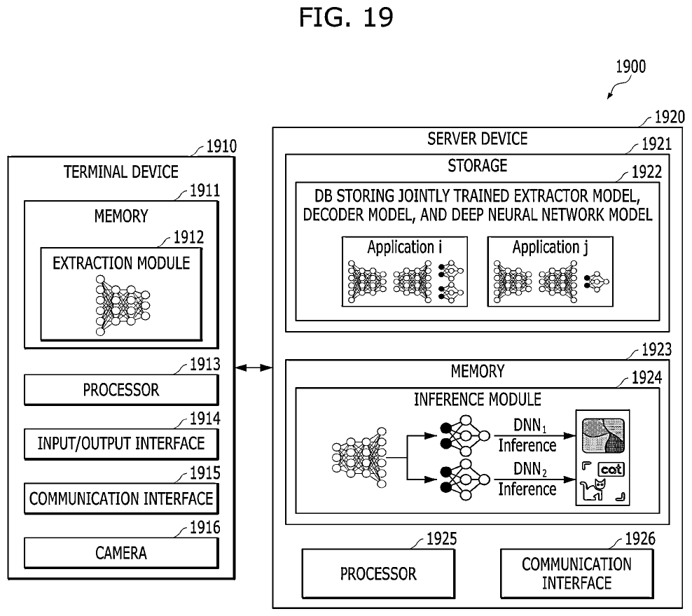

FIG. 19 is a block diagram illustrating an offloading system according to an embodiment. Referring to FIG. 19, an offloading system 1900 may include a terminal device 1910 and a server device 1920. The method of processing offloaded data according to embodiments disclosed herein may be performed by the server device 1920, or may be jointly performed by the server device 1920 and a separate server device. In embodiments described below, it should be interpreted that operations described as being performed by the offloading system 1900 may also be performed a separate computing device, such as a separate server device, unless otherwise specified. The terminal devices 1310 and 1510 and the server devices 1320 and 1520 of FIGS. 13 and 15 correspond to the terminal device 1910 and the server device 1920, and thus, redundant descriptions thereof are omitted.

Referring to FIG. 19, a terminal device 1910 according to an embodiment may include a memory 1911, a processor 1913, an input/output interface 1914, and a communication interface 1915. However, the components of the terminal device 1910 are not limited to the above-described examples, and the terminal device 1910 may include more or fewer components than the above-described components. In an embodiment, at least some of the memory 1911, the processor 1913, the input/output interface 1914, and the communication interface 1915 may be implemented in a single chip, and the processor 1913 may include one or more processors.

The memory 1911 is a component for storing various programs or data, and may include a storage medium, such as read-only memory (ROM), random-access memory (RAM), a hard disk, a compact disc ROM (CD-ROM), or a digital versatile disc (DVD), or a combination of storage media. The memory 1911 may not be a separate component and may be included in the processor 1913. The memory 1911 may include a volatile memory, a nonvolatile memory, or a combination of a volatile memory and a nonvolatile memory. The memory 1911 may store a program for performing operations according to embodiments described above or to be described below. The memory 1911 may provide stored data (e.g., images, videos, audios, texts, and sensor values) to the processor 1913 according to a request of the processor 1913.

The memory 1911 may include an extraction module 1912. The extraction module 1912 may correspond to at least one instruction for generating latent representation data by using an extractor model that receives original data as an input.

The processor 1913 is a component configured to control a series of processes such that the terminal device 1910 operates according to the embodiments described above with reference to FIGS. 13 to 18, and may include one or more processors. In this case, the one or more processors may be a general-purpose processor, such as a central processing unit (CPU), an application processor (AP), or a digital signal processor (DSP), a dedicated graphics processor, such as a graphics processing unit (GPU) or a vision processing unit (VPU), or a dedicated artificial intelligence processor, such as a neural processing unit (NPU).

The processor 1913 may write data in the memory 1911 or read data stored in the memory 1911, and in particular, may execute a program stored in the memory 1911 to process data according to a predefined operation rule or an artificial intelligence model (e.g., an extractor model). Accordingly, the processor 1913 may perform the operations described above with reference to the embodiments, and the operations described above to be performed by the terminal device 1910 in the embodiments may be performed by the processor 1913 unless otherwise specified. For example, in a case in which the one or more processors are dedicated artificial intelligence processors, the dedicated artificial intelligence processor may be designed in a hardware structure specialized for processing a particular artificial intelligence model (e.g., an extractor model).

The input/output interface 1914 may include an input interface (e.g., a touch screen, a hard button, or a microphone) for receiving a control command or information from a user, and an output interface (e.g., a display panel or a speaker) for displaying a result of executing an operation or a state of the terminal device 1910 according to control by the user.

The communication interface 1915 is a component for transmitting and receiving signals (e.g., control commands and data) to and from an external device by wire or wirelessly, and may include a communication chipset that supports various communication protocols. The communication interface 1915 may receive a signal from the outside and output the signal to the processor 1913, or transmit, to the outside, a signal output from the processor 1913. For example, the communication interface 1915 may transmit latent representation data to the server device 1920. For example, the communication interface 1915 may receive inferred data from the server device 1920.

In an embodiment, the terminal device 1910 may further include a camera 1916. The camera 1916 may receive light through a lens. The camera 1916 may include an image processor. The image processor (not shown) may generate image data regarding an external object, based on received light. The image data may be data to be input to an extractor model.

The server device 1920 according to an embodiment may include a storage 1921, a memory 1923, a processor 1925, and a communication interface 1926. However, the components of the server device 1920 are not limited to the above-described examples, and the server device 1920 may include more or fewer components than the above-described components. In an embodiment, at least some of the storage 1921, the memory 1923, the processor 1925, and the communication interface 1926 may be implemented in a single chip, and the processor 1925 may include one or more processors.

The storage 1921 may store originals or backup copies of various pieces of data used by the processor 1925. The storage 1921 may be used as an auxiliary storage device of the server device 1920. For example, the storage 1921 may be implemented as a hard disk drive (HDD) or a solid-state drive (SSD). Unlike as illustrated in FIG. 19, the storage 1921 may be outside the server device 1920. In an embodiment, the storage 1921 may include a database (DB) 1922 storing an extractor model, a decoder model, and a DNN model, which are jointly trained. The DB 1922 may include the jointly trained extractor model, decoder model, and DNN model, which correspond to a particular application.

The memory 1923 is a component for storing various programs or data, and may include a storage medium, such as ROM, RAM, a hard disk, a CD-ROM, or a DVD, or a combination of storage media. The memory 1923 may not be a separate component and may be included in the processor 1925. The memory 1923 may include a volatile memory, a nonvolatile memory, or a combination of a volatile memory and a nonvolatile memory. The memory 1923 may store a program for performing operations according to embodiments described above or to be described below. The memory 1923 may provide stored data (e.g., images, videos, audios, texts, and sensor values) to the processor 1925 according to a request of the processor 1925.

The memory 1923 may include an inference module 1924. The inference module 1924 may correspond to at least one instruction for decoding offloaded data by using a decoder model and outputting inferred data corresponding to the offloaded data by using a DNN model having received the decoded data as an input.

The processor 1925 is a component configured to control a series of processes such that the server device 1920 operates according to the embodiments described above with reference to FIGS. 13 to 18, and may include one or more processors. In this case, the one or more processors may be a general-purpose processor, such as a CPU, an AP, or a DSP, a dedicated graphics processor, such as a GPU or a VPU, or a dedicated artificial intelligence processor, such as an NPU.

The processor 1925 may write data in the storage 1921 or the memory 1923, or read data stored in the storage 1921 or the memory 1923, and in particular, may execute a program stored in the storage 1921 or the memory 1923 to process data according to a predefined operation rule or an artificial intelligence model (e.g., a decoder model or a DNN model). Accordingly, the processor 1925 may perform the operations described above with reference to the embodiments, and the operations described above to be performed by the server device 1920 in the embodiments may be performed by the processor 1925 unless otherwise specified. For example, in a case in which the one or more processors are dedicated artificial intelligence processors, the dedicated artificial intelligence processor may be designed in a hardware structure specialized for processing a particular artificial intelligence model (e.g., a decoder model or a DNN model).

The communication interface 1926 is a component for transmitting and receiving signals (e.g., control commands and data) to and from an external device by wire or wirelessly, and may include a communication chipset that supports various communication protocols. The communication interface 1926 may receive a signal from the outside and output the signal to the processor 1925, or transmit, to the outside, a signal output from the processor 1925. For example, the communication interface 1926 may receive latent representation data from the terminal device 1910. For example, the communication interface 1926 may transmit inferred data to the terminal device 1910.

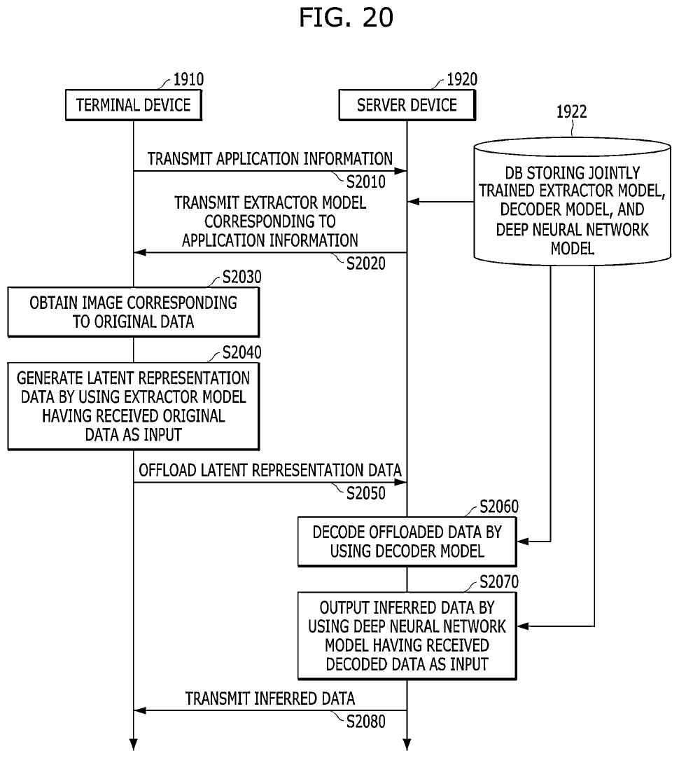

FIG. 20 is a flowchart illustrating a method of processing offloaded data according to an embodiment. Hereinafter, the method of processing offloaded data (or an operating method of an offloading system) is described with reference to FIGS. 19 and 20. For convenience of description, the descriptions provided above with reference to FIGS. 13 to 18 are omitted. Referring to FIG. 20, the method of processing offloaded data may include operations S2010 to S2080. Operations S2010 to S2080 may be performed by the terminal device 1910 (or the processor 1913 of the terminal device 1910) and/or the server device 1920 (or the processor 1925 of the server device 1920). The method of processing offloaded data of the disclosure is not limited to the operations illustrated in FIG. 20, and any one of the operations illustrated in FIG. 20 may be omitted, and operations not illustrated in FIG. 20 may be further included.

In operation S2010, the terminal device 1910 may transmit application information to the server device 1920. The server device 1920 may receive the application information. For example, the application information may include information about an application executed by the terminal device 1910. For example, an arbitrary application may correspond to an extractor model, a decoder model, and a DNN model, which are jointly trained.

In operation S2020, the server device 1920 may transmit an extractor model corresponding to the application information. The server device 1920 may load the extractor model from the DB 1922.

In operation S2030, the terminal device 1910 may obtain an image corresponding to original data.

In operation S2040, the terminal device 1910 may generate latent representation data by using the extractor model having received the original data as an input.

In operation S2050, the terminal device 1910 may offload (or transmit) the latent representation data onto the server device 1920. The server device 1920 may receive the offloaded latent representation data.

In operation S2060, the server device 1920 may decode the offloaded data by using a decoder model. The server device 1920 may load the decoder model from the DB 1922.

In operation S2070, the server device 1920 may output inferred data by using a DNN model having received the decoded data as an input. The server device 1920 may load the DNN model from the DB 1922.

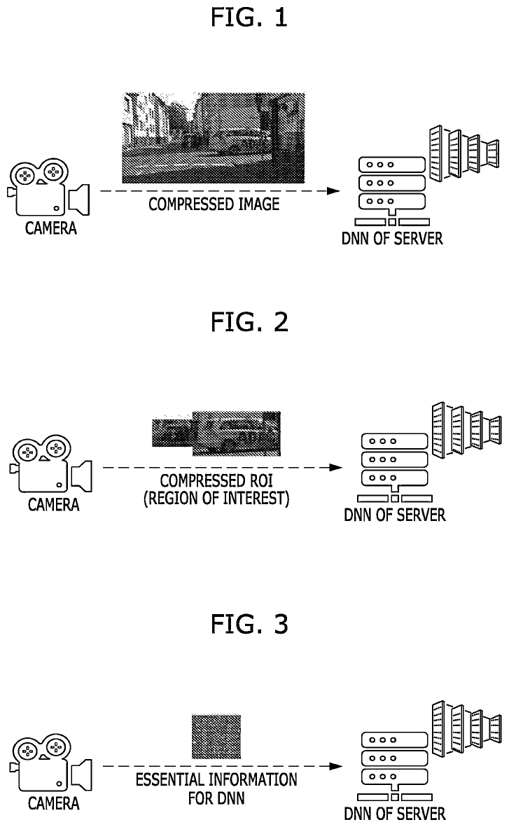

In operation S2080, the server device 1920 may transmit the inferred data to the terminal device 1910. The terminal device 1910 may receive the inferred data. According to the disclosure, the encoder, decoder, and DNN illustrated in FIGS. 1 to 12 may correspond to the extractor model, decoder model, and DNN model illustrated in FIGS. 13 to 20, respectively.

A method of processing offloaded data according to an embodiment may include receiving the offloaded data from a terminal device, decoding the offloaded data by using a decoder model, and outputting inferred data corresponding to the offloaded data by using a DNN model having received the decoded data as an input. According to an embodiment, the offloaded data may include latent representation data generated by an extractor model having received original data as an input. According to an embodiment, the extractor model, the decoder model, and the DNN model may be jointly trained by using loss information of the DNN model.

According to an embodiment, the extractor model and the decoder model may be implemented as an autoencoder model.

According to an embodiment, a size of the latent representation data may be predefined.

According to an embodiment, the decoding may include transforming the offloaded data into a format of an input value of the DNN model.

According to an embodiment, the decoder model may include a single upsampling layer and a single convolutional layer.

According to an embodiment, the DNN model may be a first DNN model, the inferred data may be first inferred data, the method may further include outputting second inferred data corresponding to the offloaded data by using a second DNN model having received the decoded data as an input, and the extractor model and the decoder model may be jointly trained by using loss information of the first DNN model and loss information of the second DNN model.

According to an embodiment, the extractor model may be trained by using a knowledge distillation technique.

According to an embodiment, the original data may include at least one of an image, a video, an audio, a text, and a sensor value to be used in an application using the DNN model.

According to an embodiment, the DNN model may be a model that performs image classification, image segmentation, image captioning, object detection, depth estimation, localization, or pose estimation, based on the original data.

According to an embodiment, the method may further include transmitting the inferred data to the terminal device.

A server device for processing offloaded data according to an embodiment may include a memory storing one or more instructions, and at least one processor configured to execute the one or more instructions stored in the memory. The at least one processor may be further configured to execute the one or more instructions to receive the offloaded data from a terminal device, decode the offloaded data by using a decoder model, and output inferred data corresponding to the offloaded data by using a DNN model having received the decoded data as an input. According to an embodiment, the offloaded data may include latent representation data generated by an extractor model having received original data as an input. According to an embodiment, the extractor model, the decoder model, and the DNN model may be jointly trained by using loss information of the DNN model.

An offloading system according to an embodiment may include a terminal device and a server device. The terminal device may include a camera configured to obtain an image corresponding to original data, a first memory storing one or more instructions, and at least one first processor configured to execute the one or more instructions stored in the first memory. The at least one first processor may be further configured to execute the one or more instructions stored in the first memory to generate latent representation data by using an extractor model having received the original data as an input, and offload the latent representation data onto the server device. The server device may include a second memory storing one or more instructions, and at least one second processor configured to execute the one or more instructions stored in the second memory. The at least one second processor may be further configured to execute the one or more instructions to receive the offloaded data from the terminal device, decode the offloaded data by using a decoder model, and output inferred data corresponding to the offloaded data by using a DNN model having received the decoded data as an input. According to an embodiment, the offloaded data may include latent representation data generated by an extractor model having received original data as an input. According to an embodiment, the extractor model, the decoder model, and the DNN model may be jointly trained by using loss information of the DNN model.

In an embodiment, a machine-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the non-transitory storage medium may include a buffer in which data is temporarily stored.

According to an embodiment, the method according to various embodiments disclosed herein may be included in a computer program product and provided. The computer program products may be traded as commodities between sellers and buyers. The computer program product may be distributed in the form of a machine-readable storage medium (e.g., a CD-ROM), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or a memory of a relay server.

According to an embodiment, a DNN-based encoder and a DNN may be connected to each other and then jointly trained by using a loss function of the DNN, and, to this end, a high compression rate may be achieved through a compression technique for DNN services, so as to enable a large-scale application service using the DNN.

According to an embodiment, by reducing the amount of data to be transmitted, with a high compression rate, a time period required for transmission may be reduced, and thus, an implementation of a low-latency service may be effectively supported.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of processing offloaded data, the method comprising:
receiving the offloaded data from a terminal device;
decoding the offloaded data by using a decoder model; and
outputting inferred data corresponding to the offloaded data by using a deep neural network model having received the decoded data as an input,
wherein the offloaded data includes latent representation data generated by an extractor model having received original data as an input, and
the extractor model, the decoder model, and the deep neural network model are jointly trained by using loss information of the deep neural network model.

2. The method of claim 1, wherein the extractor model and the decoder model are implemented as an autoencoder model.

3. The method of claim 1, wherein a size of the latent representation data is predefined.

4. The method of claim 1, wherein the decoding comprises transforming the offloaded data into a format of an input value of the deep neural network model.

5. The method of claim 4, wherein the decoder model includes a single upsampling layer and a single convolutional layer.

6. The method of claim 1, wherein the deep neural network model is a first deep neural network model,
the inferred data is first inferred data,
the method further comprises outputting second inferred data corresponding to the offloaded data by using a second deep neural network model having received the decoded data as an input, and
the extractor model and the decoder model are jointly trained by using loss information of the first deep neural network model and loss information of the second deep neural network model.

7. The method of claim 1, wherein the extractor model is trained by using a knowledge distillation technique.

8. The method of claim 1, wherein the original data includes at least one of an image, a video, an audio, a text, and a sensor value to be used in an application using the deep neural network model.

9. The method of claim 1, wherein the deep neural network model is a model that performs image classification, image segmentation, image captioning, object detection, depth estimation, localization, or pose estimation, based on the original data.

10. The method of claim 1, further comprising transmitting the inferred data to the terminal device.

11. A server device for processing offloaded data, the server device comprising:
a memory storing one or more instructions; and
at least one processor configured to execute the one or more instructions stored in the memory,
wherein the at least one processor is further configured to:
receive the offloaded data from a terminal device;
decode the offloaded data by using a decoder model; and
output inferred data corresponding to the offloaded data by using a deep neural network model having received the decoded data as an input,
wherein the offloaded data includes latent representation data generated by an extractor model having received original data as an input, and
the extractor model, the decoder model, and the deep neural network model are jointly trained by using loss information of the deep neural network model.

12. The server device of claim 11, wherein the extractor model and the decoder model are implemented as an autoencoder model.

13. The server device of claim 11, wherein a size of the latent representation data is predefined.

14. The server device of claim 11, wherein the at least one processor is further configured to execute the one or more instructions to, in the decoding, transform the offloaded data into a format of an input value of the deep neural network model.

15. The server device of claim 14, wherein the decoder model includes a single upsampling layer and a single convolutional layer.

16. The server device of claim 11, wherein the deep neural network model is a first deep neural network model,
the inferred data is first inferred data,
the at least one processor is further configured to execute the one or more instructions to output second inferred data corresponding to the offloaded data by using a second deep neural network model having received the decoded data as an input, and
the extractor model and the decoder model are jointly trained by using loss information of the first deep neural network model and loss information of the second deep neural network model.

17. The server device of claim 11, wherein the extractor model is trained by using a knowledge distillation technique.

18. The server device of claim 11, wherein the original data includes at least one of an image, a video, an audio, a text, and a sensor value to be used in an application using the deep neural network model.

19. The server device of claim 11, wherein the deep neural network model is a model that performs image classification, image segmentation, image captioning, object detection, depth estimation, localization, or pose estimation, based on the original data.

20. An offloading system comprising:
a terminal device; and
a server device,
wherein the terminal device comprises:
a camera configured to obtain an image corresponding to original data;
a first memory storing one or more instructions; and
at least one first processor configured to execute the one or more instructions stored in the first memory,
wherein the at least one first process is further configured to:
generate latent representation data by using an extractor model having received the original data as an input; and
offload the latent representation data onto the server device,
the server device comprises:
a second memory storing one or more instructions; and
at least one second processor configured to execute the one or more instructions stored in the second memory,
wherein the at least one second processor is further configured to:
receive the offloaded data from the terminal device;
decode the offloaded data by using a decoder model; and
output inferred data corresponding to the offloaded data by using a deep neural network model having received the decoded data as an input, and
the extractor model, the decoder model, and the deep neural network model are jointly trained by using loss information of the deep neural network model.
